(19) United States
(12) Patent Application Publication
(10) Pub. No.: US 2012/0141251 A1
(43) Pub. Date: Jun. 7, 2012

(54) METHOD AND DEVICE FOR PREDICTING THE INSTABILITY OF AN AXIAL COMPRESSOR

(75) Inventor: Efrén Moreno Benavides, Madrid (ES)

(73) Assignee: UNIVERSIDAD POLITÉCNICA DE MADRID, Madrid (ES)

(21) Appl. No.: 13/266,793

(22) PCT Filed: Aug. 20, 2010
(86) PCT No.: PCT/ES10/70563

§ 371 Date: Oct. 28, 2011

(30) Foreign Application Priority Data
Aug. 21, 2009 (ES) P200930614

(51) Int. Cl. F04D 27/00; G06F 15/00; G08B 21/00; G01K 17/00

(52) U.S. Cl. 415/1; 702/136; 340/603

(57) ABSTRACT

The present invention relates to a method and device for predicting the instability of an axial compressor, which is applicable to the aerospace and industrial field, specifically to the field of one- or multi-stage axial compressors. The invention relates to a method and a device for predicting the instability of an axial compressor which allows protecting said compressor from the instabilities of devices of this type. The present invention could be used in all those products requiring the use of said compressors, such as aircraft engines, turbofans, turboshafts, or turboprops in the aerospace field, gas turbines in the energy field, air conditioning systems in the civil field, and gas compression systems in the chemical or oil industry.

### FIELD OF THE INVENTION

The present invention applies to the aerospace and industrial field, specifically to the field of one- or multi-stage axial compressors.

The invention relates to a method and a device for predicting the instability of an axial compressor which allows protecting said compressor against the instabilities of devices of this type. The present invention could be used in all those products requiring the use of said compressors, such as aircraft engines, turbofans, turboshafts, or turboprops in the aerospace field, gas turbines in the energy field, air conditioning systems in the civil field, and gas compression systems in the chemical or oil industry.

### STATE OF THE ART

One of the most important aspects for determining the performance of machines equipped with axial-flow compressors is the instability of the compression system. A two-dimensional graph can be defined for an axial compressor in which the x-axis represents the pressure difference and the y-axis represents the mass flow. This same graph can be defined for a single row of blades. Depending on the capacity defined by both variables and according to the work conditions, the operating point of the compressor will be located in a point of the plane. The plane comprises two regions, a stable region and an unstable region. Both regions are separated by a line which is referred to as the “stability line” and establishes the boundary between both regions. Typically, the stability line is such that its intersection with a horizontal line corresponding to a constant pressure path, leaves the unstable region to the left (lower mass flows) and the stable region to the right (greater mass flows). Predicting the instability in a compressor is predicting that a determined operating capacity is located to the left of the stability line.

Although there are works with analytical results and also with numerical results which allow establishing stable work conditions with a certain degree of safety (by means of experiments; for example, by following constant pressure conditions and varying the mass flow, it is possible to gradually determine points of the plane where instabilities appear), the determination and configuration of this stability line (typically represented by means of a increasing function) has not been analytically established up until now.

This instability can manifest in different ways and accordingly it usually receives different names, such as stall, rotating stall, deep stall and surge.

Particularly, the stall conditions indicate that the boundary layer in the blades of the rotor is shed because the flow is unable to follow the profile of the blade and therefore said aerodynamic profile no longer exerts a correct “lift” action. As a result, the efficiency drops, which can lead to the situation in which it is impossible to maintain the pressure difference in the compression stage.

The terms stall, rotating stall and deep stall refer to different physical phenomena the effect of which is the disruption from a lesser to higher degree of the internal flow of the compressor.

The term surge refers to the limit condition in which there is a strong loss of compression.

The efforts to understand and improve the stability of axial compressors, especially for aeronautic propulsion applications, which have been made over the last few decades have allowed understanding that there are several triggers or events initiating the phenomenon. A possible mechanism referred to as modal inception is known, which occurs when there are long wavelength perturbations the amplitude of which wavelength gradually increases under the instability conditions of the entire compression system. Another possible mechanism referred to as spike inception is known, which involves short wavelength perturbations the amplitude of which wavelength rapidly increases under large angles of incidence of the rotor. However, there may still be other mechanisms. In fact, it has been asserted that the short and long wavelength perturbations alone are not enough to predict the instability and that all the wavelengths should be considered in order to describe the phenomenon. Furthermore, the situation is even more complex given that, as is known, the precursors of the instability can be coupled.

Thus, the publication of Day et al. [Day, I. J., Breuer, T. Escuret, J., Cherrett, M. and Wilson, A., Stall Inception and the prospects for active control in four high speed compressors, ASME J. Turbomachinery, Vol. 121, pp. 18-27] shows the study of four high speed compressors for aeronautical applications in which it is concluded that at the time of its publication, the precursors of the instabilities were still not well known in engines of this type and to demonstrate this the following experimental evidence was submitted:

1) in two of the compressors, when they operated at maximum capacity, a new type of precursor of the high-frequency instability was detected,

2) although in most causes the rotating stall failure preceded the surge failure, the origin of the instability could not be identified in terms of low or high wavelength perturbations,

3) in one of the compressors the instability occurred so quickly that the onset of the rotating stall could not be detected before the loss of compression, and

4) in all the compressors there were perturbations in all the rotation operating conditions.

The precursors of the instabilities continue to be unknown today in engines of this type.

In addition, the fluid structures of the regions in which the compressor stalls have also been the object of in-depth study. For example, it is asserted that during the evolution of an instability initiated by low-frequency perturbations, high-frequency perturbations can appear and disappear, but that they ultimately remain. With an additional reduction of the air flow going through the compressor, both perturbations coexist simultaneously and the instability leads to a large region of the compressor stalling and to a deep stall condition. It is also asserted that though it seems obvious that both phenomena are associated with instability, the behavior of the low- and high-frequency perturbations in the process is unknown. The complexity of the phenomenon has also been discussed and investigated numerically in a single-stage compressor elaborated by NASA, from which it was deduced that the low-frequency modes dominated the flow for mass air flows below and above a determined range of mass flows. However, it was subsequently argued that this result contradicted the explanation which asserted that the loss of compression is due to low-frequency perturbations the characteristic time of which exceeds the dwell time. It has also been shown that the factors which condition the evolution of the compressor towards stall have still not been clarified.

In addition, as Greitzer established in his publication [Greitzer, E. M. Surge and Rotating Stall in Axial Flow Compressors. Part I: Theoretical Compression System Model. Engineering for power, Vol. 98, No. 2, 1976, pp. 190, 198.], the times which are needed for a stall region to develop within the compressor can be long enough so that the flow going through the compressor experiences significant changes. He thus generated a first order mathematical model to simulate the effect that this time delay produced in the evolution of transients during the instability. However, the prediction process was not complete given that it did not include the model which predicted the performances of the compressor in the low mass flow regions in which the instabilities were present.

Patent JP 2008223624 discloses a prediction system in which a stall sign is established which warns of the proximity of the operating point to instability, together with a control system which corrects the situation. This system computes an index for evaluating the risk existing at a determined time that the instability will occur. The system comprises a time averaging and another circumferential averaging for evaluating the risk index, as well as a time correction for compensating the possible time delays generated in the averaging operations only performed on the pressure existing at different points of the compressor.

Patent WO 2007135991 discloses an apparatus for computing a risk index, which warns of the proximity to the unstable region, based on the analysis of the time series produced by one or several pressure sensors placed in the wall of the compressor and distributed along the circumference. A stable and highly precise risk evaluation index capable of managing active control systems is thus obtained. As an example of the type of control system, patent JP 2003227497, which describes a system of grooves which open and close according to the signal produced by a risk index, such that the compressor can continuously operate in the stable region as a result of the increase of the air flow going through it, can be consulted.

A somewhat simpler prediction and control system can be found in JP 2001132685. In this device, the instability is avoided by means of a pressure sensor installed in the casing of the compressor and an amplifier which obtains the pressure variations, which are subsequently converted to a direct current. When this direct current exceeds a previously determined value, the active control system is activated, which system can consist of stopping the installation or of opening bleed valves which increase the flow. Though this system has a prediction technique that is slightly different from the previous ones, its precision continues to be compromised because it exclusively uses pressure as the only risk variable.

U.S. Pat. No. 5,908,462 describes a completely different approach to solve this technological problem. This system uses dimensional analysis, the similitude of the system when it is written in dimensionless notation, to derive a surge limit that is invariant to suction conditions of the compressor which can vary, for example, by changing the geometry of the inlet guide blades. The method uses the linear or nonlinear combination of dimensionless variables different from those used before. Nevertheless, the main limitation of this patent is that the optimal ratio of the dimensionless variables which makes it possible to predict the risk index with greater reliability is unknown.

Finally, WO 9403862 describes a method for monitoring and controlling a compressor. The device again is based on measuring pressure fluctuations with at least one pressure sensor and obtaining a frequency signal having at least one peak in the region of characteristic frequencies assigned to one of the compression stages and which is used to generate at least one parameter indicative of the operational status of the compressor. In the event that this parameter lies beyond a predetermined range, a signal is generated which is used to control the compressor. Again, this patent dispenses with physical parameters other than pressure.

It is therefore desirable to provide a device and method for protecting that allows knowing the imminent onset of instability, as well as the margin of safety existing at an operating point both in the operation and in the design, preventing the drawbacks existing in the earlier systems of the state of the art.

### DESCRIPTION OF THE INVENTION

The invention solves and improves limitations existing in the state of the art with respect to the aforementioned patents, which perform an averaging only with respect to the pressure existing at different points of the compressor. For the purpose of preventing the compressor from stalling without prior notice, the present invention takes a measurement in which a larger number of fluid variables is involved, such as the rotational velocity of the compressor, or the outlet temperature thereof. In one embodiment, this measurement entails averaging the acquired values. A more complete and stable measurement is thus obtained for predicting the instability because it adds more relevant physical information for the computation of the risk index. In addition, the invention solves the lack of knowledge about the optimal ratio between the dimensionless variables such that the risk index becomes predictable with greater reliability and robustness at all the operating points of the compressor.

A first aspect of the invention relates to a method capable of predicting the instabilities of a one- or multi-stage axial compressor. More specifically, it relates to a method capable of computing a risk index such that a control system which is installed in the engine or machine in which the compressor operates will have the necessary information to evaluate the degree of danger existing at said operating point and will carry out the necessary actions to prevent the instabilities which would lead to the situation of danger.

According to a second aspect of the invention, another object of this invention is a device suitable for carrying out the method for predicting the instability in one or in all the stages of the compressor as well as for protecting each stage by using control means capable of changing the operating conditions thereof.

The proposed device comprises a series of measuring devices (in the embodiment it will be seen that it comprises calculators, sensors and systems for conditioning the signal) the purpose of which is to provide either by direct measurement, by computation from indirect measurements, or by estimating the parameters necessary for the computation, a value of the pressures, temperatures and velocities at the outlet of each stage, means if the latter are weighted; and a computing device the purpose of which is to compute a risk index for each stage from the values provided by the measuring devices. According to one embodiment, a control system which allows correcting the situation both in the operation and in the design is supplied with the set of risk indexes.

Therefore, according to an embodiment of this second aspect of the invention, a device is provided which is capable of producing a risk signal, which is a function of the proximity of the operating point to the stability line, for each row of blades that can be used to manage an active control system. In this invention, a row of blades is each of the rotors or stators forming the compressor.

The device consists of a computing unit which takes, for each row of blades (rotor or stator), the static pressures at the inlet and the outlet of the row, the static enthalpy at the outlet, the rotational velocity of the row, the absolute velocity (magnitude and direction) of the fluid at the outlet of the row and the axial solidity thereof and generates a risk index which is a claim of the present invention. This risk index is defined below.

Where subscript j is in charge of identifying the row (it can be a rotor or a stator) of the evaluated compressor, subscript I specifies the properties at the inlet of the row, and subscript O specifies the properties at the outlet of the row, then the risk index for row j is evaluated by means of the expression:

$${IR}_{j} = exp [ 1 + \frac{2 {h}_{j ; O} [ {( \frac{{P}_{j ; I}}{{P}_{j ; O}} )}^{\frac{{γ}_{j} - 1}{{γ}_{j}}} - 1 ]}{{[ {( {V}_{x} )}_{j ; O} + {( {σ}_{x} )}_{j} \vert {( {V}_{θ} )}_{j ; O} - {U}_{j} \vert ]}^{2}} ] \qquad ( Equation 1 )$$

The variables in this expression are defined as can be seen in Table 1.

TABLE 1
Set of variables used to define the risk index of a row of blades.

| | |
|---|---|
| IRⱼ | Risk index of the row j |
| h_{j;O} | Static enthalpy of the gas at the outlet of the row j |
| P_{j;I} | Static pressure of the gas at the inlet of the row j |
| P_{j;O} | Static pressure of the gas at the outlet of the row j |
| γⱼ | Ratio of specific heats of the gas in the row j |
| (Vₓ)_{j;O} | Axial velocity of the gas at the outlet of the row j |
| (V_{θ})_{j;O} | Absolute tangential velocity of the gas at the outlet of |
| | the row j |
| Uⱼ | Tangential velocity of the row (its value is zero if the |
| | row is a stator) |
| (σₓ)ⱼ | Axial solidity of the row j. |

According to the present invention, this risk index predicts an instability in the row j, and therefore in the compressor, when IRⱼ is less than a reference value I_{ref}, preferably one. This risk index predicts a stable behavior of the stage j when IRⱼ is greater than the reference value I_{ref}. Therefore, the instability line of the row is at those operating points where IRⱼ is equal to I_{ref}.

When the reference value I_{ref} is one, there is a criterion for establishing a prediction about the instability. Nevertheless, it is possible to consider a shifted reference value I_{ref}. If a safety value v_{saf}>0 is defined and I_{ref} is 1+v_{saf}, then the prediction for the work conditions of the compressor is instability with a margin of safety defined by v_{saf}. The protective actions adopted using this prediction will be put into effect sooner than if the value 1 for I_{ref} is used in the assessment of the risk index IRⱼ.

In contrast, there will be situations in which, assuming the risk, the compressor is allowed to slightly enter the instability region. In this case, having defined a risk value vᵣ>0, the value to be taken for I_{ref} is 1-vᵣ.

Notwithstanding the foregoing, the preferred value for I_{ref} is considered as one and the following descriptions and reasoning will be carried out using one but it does not mean that the previous generalization for the reference value I_{ref} cannot be applied.

Given that the relevant information meets the condition IRⱼ=1 and the good mathematical properties of the function shown in Equation 1, since it is well defined at any operating point, is continuous and derivable, all those risk indexes derived from the foregoing such that they reproduce the same condition of stability with the same mathematical properties are also object of the present invention. For example, the following are also risk indexes: IRⱼ−1 when IRⱼ−1=0; ln(IRⱼ) when ln(IRⱼ)=0; ln(IRⱼ)−1 when ln(IRⱼ)−1=1; IRⱼ² when IRⱼ²=1; as well as equivalent expressions obtained from performing mathematical operations on the previous indexes. Therefore, those expressions which are deduced from the condition given by equation 1, equal to 1 by applying changes by algebraic manipulation such that they only modify the way of expressing the same condition shall be considered equivalent expressions. The same applies to the case in which I_{ref} is not one, the preferred value.

With the stability criterion object of the present invention, the compressor is considered completely stable when all its rows are, i.e., when IRⱼ is greater than one for any value of j (including rotors and stators).

With the stability criterion object of the present invention, the compressor is considered operatively stable when all its rotors are, even if its stators are not, i.e., when IRⱼ is greater than one for any value of j for which Uⱼ>0.

The variables of Table 1, which are necessary for computing the risk index, must be understood in the context of the present invention as both time and spatially characteristic values of the row. For this reason, said variables can be obtained by pooling the information from several spatial and time positions by means of filtering techniques which eliminate rapid fluctuations and variations while they retain the slow ones: in this sense, they are both time and spatially averaged variables, i.e., they can be the instantaneous pressures or velocities existing in a determined axial and azimuthal position of the row, for example on the casing of greater radius in a determined angular position thereof, or they can be a spatial averaging of the values measured at different points angularly distributed over both the outer and the inner casing, or measurements can be taken in the stream located far from of the walls, or it can be the result of a weighting of all of them. Likewise, the velocities and the pressures can, though do not have to be, understood as a time averaged value over a time range greater than the natural fluctuations generated by the passage of the blades and the noise from the engine or machine. Likewise, the axial solidity (σₓ)ⱼ must be understood as the characteristic value obtained from multiplying the number of blades Z of the row j by the axial chord cₓ and from dividing said result by 2πr, where r is a characteristic value of the radius of the blade in the row j and cₓ is a characteristic value of the axial chord in the row j. For example, the values of any intermediate section of the blade, or the values of the section of the tip of the blade, or the values of the section with less axial solidity, could be taken as the characteristic value of the axial chord and of the radius.

Likewise, the variables of Table 1 can be obtained by direct measurement, by derivation from the corresponding indirect magnitude measurements, and by computation from the corresponding physics equations. For example, the following can be obtained:
the static pressures by means of piezoresistive pressure sensors, piezoelectric pressure sensors, or a combination of both;
the static enthalpy by means of thermocouples located such that they acquire the static temperature and the subsequent computation of the enthalpy using of thermodynamic laws implemented in the device;
and the velocities:
   1) the axial and azimuthal velocities by means of hot wire or plate anemometers;
   2) indirectly by means of measuring the static and stagnation pressures, for example using pitot tubes;
   3) they can be estimated by means of computation from the compressor geometry, from the compressor map; etc.

The device is therefore a detector of the instability of the compressor, if the compression system is provided with one or a plurality of sensors, each placed in any one position of the set of possible positions, such that a characteristic, preferably time stable signal is generated which supplies a computing device, where Equation 1 is implemented, which equation generates the index IRⱼ that will serve to evaluate the risk of instability. An index or set of indexes is thus obtained which allows evaluating the risk of the loss of compression.

Therefore, there is a signal in the device with the capacity to detect the loss of compression in the row j and, more importantly, of predicting the point at which it will occur. It is a device which depends on variables, which are or are not time and spatially averaged, that supply an analytical expression, which is well defined for all the operating points, such that reliable, robust and stable control systems can be achieved. Furthermore, the inlet variables can be obtained by means of direct measurement and subsequent time and spatial average, so the criterion is independent of the inlet or outlet perturbations caused by the rows of blades before or after the monitored row and by the actual active control systems. The stability limit of the row, given by the condition IRⱼ=1, is independent of the operating conditions, such that an operating point can have an IRⱼ that can be far from or close to said line. As has been described above, even though the theoretical value at which the instability occurs is established by IRⱼ=1, those devices which use the IRⱼ=I_{ref} criterion where in practice I_{ref}, the reference value, is a value (usually close to one) which takes into account the possible deviations from the theoretical value produced by the errors in the measurement, averaging and estimation of parameters, are also object of the present invention.

The IRⱼ value of the real operating point is a number which can be used to implement the algorithms for the prevention of instabilities due to the fact that it is a signal which specifies the level of safety of the operating point in each row and which could therefore be used to control the compressor or the machine in which it is installed. The loss of compression or the onset of the instability can be prevented by means of control algorithms which could, for example, vary the suction conditions, by means of changing the angle of incidence of the guide blades, by means of opening bleed valves, etc. This is because the risk index of each stage is computed in real time by means of the information captured by the sensors installed in the monitored row.

Therefore, the technological problem solved by the present invention is that of being able to determine the degree of safety of the operating point of the compression system for the purpose of reporting on the working of the compressor and preventing this compressor from stalling, or from entering a potentially dangerous region, without prior notice. The relevant physics of the problem is included by means of Equation 1, not only the evolution of the pressure at different points of the compressor, while at the same time it presents good mathematical properties such as the fact that the equation is well defined, is continuous and derivable at any operating point. An index or set of indexes is thus obtained which allows evaluating the risk of a loss of compression, provided with high noise immunity, high sensitivity and high stability, which entails a high reliability in the active control systems which are implemented in the control devices.

Therefore, the principal advantage of the present invention with respect to other possible solutions is that it allows implementing an analytical algorithm for predicting instabilities which is simple, precise, reliable and robust. Its information can therefore be used to perform the corrective actions considered appropriate in each case for the purpose of maintaining the safety and integrity of the entire system.

As has been described, the invention which is presented contemplates a method for predicting the instability of an axial compressor according to claim 1

In an axial compressor comprising one or more rows of blades of rotors and stators, the risk index is evaluated in at least one row. If the measurement is carried out in a plurality of rows, when the risk index of any of them is less than one, the method determines that there is a condition of instability.

If the measurements are averaged, they allow a stable method such that a device suitable for carrying out said method will be capable of predicting the instability under any circumstance.

The prediction of the instability allows performing later steps in the method which give rise to the protection of the compressor. One of these steps is acting by means of corrective measurements on the work conditions of the compressor, shifting it to a stable region.

In a preferred embodiment, the method for the prediction can comprise the use of control means which generate a control signal depending on IRⱼ and act on the geometry and parameters of the compressor.

Another step which can be carried out in the method of the invention is the generation of an alarm signal. Preferably, the IRⱼ value corresponding to the tripping of one or several alarms in the method for prediction in question is less than or equal to one or to a value previously established depending on the desired margin of safety.

All those methods determined by any of the combinations provided in independent claims 2 to 9 are considered to be incorporated by reference in this description.

Another object of this invention is the device according to claim 10, and particularly of dependent claims 11 to 16, suitable for carrying out the method for predicting the instability; and optionally the subsequent action with alarm measurements, correction of the operating conditions of the compressor or both.

In this device, the conditioning means of the measuring means can be configured to compute, from the measurements obtained by the sensing means, the variables used by the computing device for computing the IRⱼ and for performing a time and spatial average thereof.

P_{j;I}, P_{j;O}, (Vₓ)_{j;O} and (V_{θ})_{j;O}, are preferably associated with values selected from:
values determined by a spatial and time position obtained in the row j of blades;
values determined by a spatial and time average of values obtained in the row j of blades;
and with a combination of the foregoing.

Finally, obtaining the variables necessary for generated the risk index can be selected from:
obtaining directly by measuring;
obtaining indirectly by computation from measuring related magnitudes;
obtaining indirectly by computation from related physics equations.

### BRIEF DESCRIPTION OF THE DRAWINGS

An embodiment of the invention will be described below by way of non-limiting illustration in reference to a series of drawings to aid in understanding the invention.

FIG. 1 schematically shows the basic geometry of an axial compressor with several rows of blades.

FIG. 2 shows the block diagram corresponding to the device object of the invention.

FIG. 3 schematically shows a characteristic section of the row of blades to be monitored.

FIG. 4 shows the breakdown of the absolute velocity V into the axial velocity Vₓ and the tangential velocity V_{θ}.

FIG. 5 shows a possible diagram for implementing a measuring device at the outlet of a row of the axial compressor.

FIG. 6 illustrates a possible measuring process.

### DETAILED DESCRIPTION OF AN EMBODIMENT

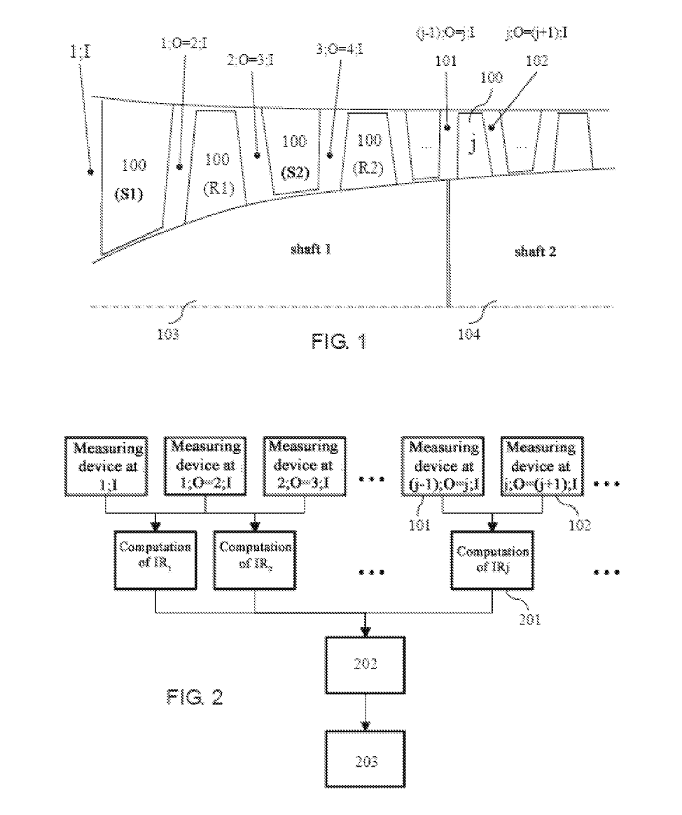

The present invention applies to axial compressors of one or several rows 100 of blades the basic geometry of which is schematically shown in FIG. 1. The sole purpose of this figure is to illustrate the application of the device object of the invention, such that the compressor could have a different number of shafts, of rotors R or of stators S, or different relative positions with respect to one another, or different auxiliary mechanisms or elements. The figure shows several rows 100 of blades, some of them are stators S1, S2, . . . and others are rotors, R1, R2, . . . . There can also be different shafts for moving the rotors R. For example, FIG. 1 schematically shows two shafts, 103 and 104, such that the depicted rotors R1 and R2 can have rotation operating conditions different from the rest. In the figure, each inlet or outlet of a row 100 of blades is referred to with the number of the row and a semicolon (;) followed by a letter I or O depending on whether it is, respectively, the inlet or the outlet of the row. In this embodiment, the outlet of the row j conveniently coincides with the inlet of the row j+1, such that it is verified that the properties of the fluid in the section j;O coincide with those of the section j+1;I, as is schematically shown in the figure. In addition, the stators S have no rotational velocity, whereas the rotors R have the rotational velocity imposed by the shaft which supports them. Thus, the tangential velocity of a blade of the row j imposed by the rotation shall generally be referred to as Uⱼ. Obviously, when the row j is a stator S, Uⱼ will be zero. The measuring devices at the inlet of the row j are referenced as 101 and the measuring devices at the outlet of the row j as 102.

FIG. 2 depicts a diagram of the device object of the invention. Said figure shows, for any complete compressor, such as that of FIG. 1 for example, the measuring devices 101 and 102 in each row 100 of blades to be monitored. These measuring devices 101 and 102, are distributed along the compressor such that they take information from the inlet and the outlet of each row 100 of blades. For each row 100 to be monitored, the computing device 201 computes, by means of Equation 1, its risk of instability index IRⱼ. Subsequently, the value of each risk index computed is used in the control means 202 for supplying a control algorithm in charge of generating a control signal which ultimately changes the geometry, or the operating point of the compressor, of the machine or of the engine 203. The control means 202 are any device acting on the compressor geometry, on the power the compressor receives, or on the air flow conditions managed both at the inlet and at the outlet.

The computing device 201 compares the risk index of each row 100 of blades with one. At this point, given that the condition IRⱼ=1 is the stability limit, it is possible that in determined applications it is appropriate to introduce a possible safety factor in the computing device 201 such that correction starts by means of the control means 202 when the risk index drops to a value somewhat greater than one. For example, the safety factor can be established at IRⱼ=1.05, such that there is a 5% margin of safety until the situation of imminent danger. Thus, the suitable decisions would be made before the imminent loss of compression and possible deviations due to errors in the measurement, averaging and estimation of parameters would be taken into account.

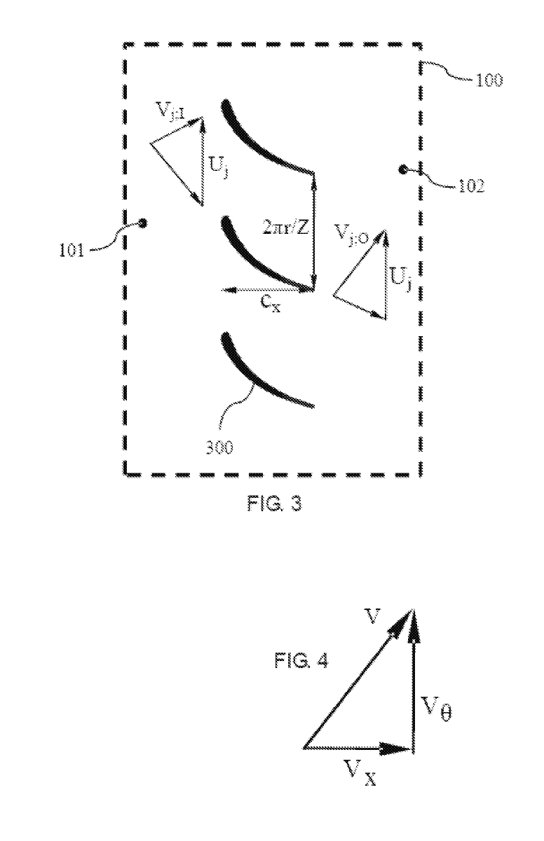

FIG. 3 schematically shows a characteristic section of the row 100 of blades to be monitored. The inlet measuring device 101 is seen before the blades 300, whereas the outlet measuring device 102 is seen after it. An essential feature of the present invention is that the risk index depends on the absolute outlet velocity V_{j;O}. This velocity is depicted in the figure along with the absolute inlet velocity V_{j;I} and the translation velocity Uⱼ. The figure also shows the axial chord cₓ and the spacing 2πr/Z of the section taken as the characteristic section of the row 100 of blades which determine the axial solidity thereof.

In order to completely determine the characteristic vector V, it is necessary to know the modulus and the direction of the velocity. FIG. 4 shows the breakdown of the absolute velocity V into the axial velocity Vₓ and the tangential velocity V_{θ}. For such reason, the outlet measuring devices 102 must be capable of directly or indirectly measuring or estimating the absolute velocity of the gas at the outlet of the row 100.

Four possible embodiments of the invention are described by way of example, and without intending to limit the scope.

### Mode 1:

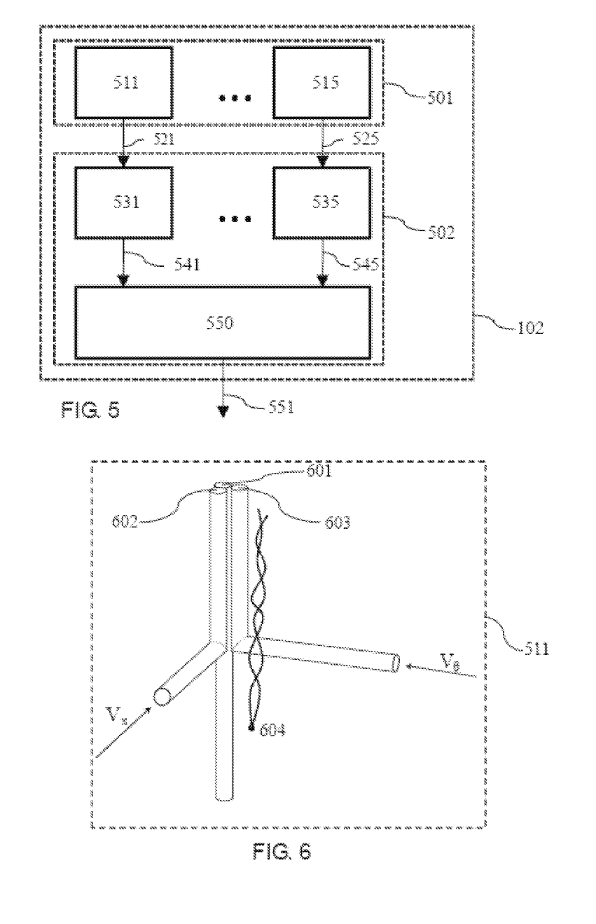

In this embodiment of the invention, schematically shown in FIG. 5, the outlet measuring device 102 of the row j 100 is formed with a set of sensors 501 and a signal conditioning and processing device 502. Generally, the number of sensors and their position will depend on the possibilities of the installation. As an example, FIG. 5 schematically shows a device with five measuring stations, 511 to 515, which, in order to have better characterization of the fluid field at the outlet of the row 100, can be alternatively distributed on the outer and inner casing of the compressor and angularly and equally spaced from one another. In turn, each measuring station 511 to 515 will be formed by a group of sensors the purpose of which will be to provide the information measured, 521 to 525, necessary for elaborating the pressure, velocity and temperature data shown in Table 1 and which are necessary for computing the risk index by means of Equation 1. Thus, the signals present in the information measured, 521 to 525, at the outlet of each group of sensors correspond with the time evolution of the magnitudes measured at each spatial position determined by the corresponding station.

The signal conditioning and processing device 502 is in charge of obtaining a time and spatial averaging from the information measured, 521 to 525, by the set of sensors 501. The time averaging can be carried out by means of applying a low pass filter to each sensor of the set of sensors 501. This time averaging can be physical (for example, if the lengths of the ducts carrying the pressure signal to the piezoresistive sensor are large enough) or electronic (if a low pass filter is incorporated at the outlet of the piezoresistive sensor or of the thermocouple). These filtering devices, 531 to 535, eliminate the rapid fluctuations in the measurement signal. The noise and high frequency time variations such as those induced by the passage of the blades in front of the sensors, are thus eliminated. The obtained low frequency signals, 541 to 545, differ from one another in that they come from measuring stations, 511 to 515, located in different spatial positions. The spatial filtering device 550 is arranged to establish a measurement which characterizes the entire outlet of the row 100 of blades. The spatial averaging can be done by taking the mean value of the obtained low frequency signals, 541 to 545, coming from the time filtering. Thus, the resulting signal 551 at the outlet of the spatial filtering device 550 is the mean value of the obtained low frequency signals 541 to 545. However, any other weighting of the obtained low frequency signals 541 to 545 could be taken to generate the outlet of the spatial filtering device 550. In the same manner, all those devices in which the spatial averaging is performed first and then the time averaging is performed, or those in which both are performed at the same time, could also be examples of application.

The resulting set of signals 551 for each of the rows 100 of the compressor characterizes the operating point of the compressor in a stable and reliable manner. They are a set of signals necessary for elaborating the pressure, velocity and temperature data shown in Table 1 and which are necessary for computing the risk index by means of Equation 1. Thus, the resulting set of signals 551 will be received in the computing device 201 for the subsequent computation of the risk index of the row 100 of blades. Obviously, the computing device 201 also requires information from the measuring device 101 at the inlet of the row, the practical embodiment of which can be implemented in the same manner as has been herein described for the measuring device 102 at the outlet of the row.

### Mode 2:

This embodiment is the same as mode 1, but it specifies a manner of carrying out the measuring stations 511 to 515 of FIG. 5. Thus, by way of example, FIG. 6 shows a possible implementation of each of these measuring stations 511 to 515. Each of these stations, for example 511, consists of a set of four sensors. The device consists of three pressure connections 601, 602 and 603 which end in their respective pressure sensors and of a temperature sensor 604. The three pressure connections, 601 to 603, are oriented with respect to the stream of gas, such that the pressure connection 602 is oriented axially and pressure connection 603 tangentially. Connection 601 is oriented transverse to the movement of the gas for the purpose of acquiring the static pressure of the stream of gas. In turn, the temperature sensor 604 is configured to acquire the static temperature.

After the corresponding time filtering devices 531 to 535 and the spatial filtering device 550, the resulting signals 551 can be used to supply the device object of the invention. For example, with the value of the static temperature present in the resulting set of signals 551, the computing device 201 can obtain (for example, by means of interpolating the gas which is compressed in the corresponding thermodynamic tables) the static enthalpy h_{j;O} and the ratio of specific heats γ_{j;O}. Thus, from the measuring devices 101 and 102 and from the averaged pressure and enthalpy values, the computing device 201 can obtain the absolute axial and tangential velocities, applying to each shaft the following expression (or one of those obtained by the laws of fluid mechanics, or by the calibration laws of the velocity sensors that are used):

$$\begin{matrix}{( {V}_{x} )}_{j ; O} = \sqrt{2 {h}_{j ; O} [ {( \frac{P ( 602 )}{P ( 601 )} )}^{\frac{{γ}_{j ; O} - 1}{{γ}_{j ; O}}} - 1 ]} & ( Equation 2 ) \\ {( {V}_{θ} )}_{j ; O} = \sqrt{2 {h}_{j ; O} [ {( \frac{P ( 603 )}{P ( 601 )} )}^{\frac{{γ}_{j ; O} - 1}{{γ}_{j ; O}}} - 1 ]} & ( Equation 3 )\end{matrix}$$

wherein P(601), P(602) and P(603) are the time and space averages of the pressures measured by the pressure connections 601, 602 and 603, respectively. Subsequently, the set of velocity, static pressure and static enthalpy signals can be used to compute the risk index provided by Equation 1.

Obviously, this figure schematically shows the working of a possible velocity sensor, which can be replaced with more complex systems, such as commercial pitot tubes or hot wire or plate anemometers, among others, without limiting the scope of the invention.

### Mode 3:

This working mode is the same as mode 2, with the exception that the pressure connections 601, 602 and 603 are replaced with hot wire anemometers.

### Mode 4:

This working mode is the same as mode 1, with the exception that the velocities, pressures and temperatures are computed by means of a numerical code of a solution of the fluid field. Thus, the measuring stations 511 to 515 are, rather than being a set of sensors, a numerical code of computation and the signals corresponding to the information measured 521 to 525, the solutions provided by the numerical code of computation at determined points of the computational grid as a function of time.

It is finally concluded that the invention comprises a device which manages a risk index with the capacity to provide a real-time warning of whether or not the operating point of the compressor is stable, and in the event that it is, it is capable of reporting the margin of safety. This risk index can be used to stabilize the system (engine or machine in which the compressor is installed) by means of an active control device. It can also be used during the design for stabilizing by means of a process of optimizing the operating points of the system of turbomachinery. The process can be implemented in the control units of said systems, in hardware or software devices, in digital integrated circuits such as application specific integrated circuits (ASICs), field programmable gate arrays (FPGAs) and in the memory of microprocessors.

Its immediate industrial application is in all those sectors in which the safety of the operation is essential, as is the case of the aerospace field. Its implementation as part of the control system of machines equipped with axial compressors allows reducing operating and maintenance costs as well as increasing the reliability of compression systems.

Having clearly described the invention, it is hereby stated that the particular embodiments described above can be subject to modifications in detail provided that such modifications do not alter the fundamental principle and essence of the invention.

1. A method for predicting the instability of an axial compressor comprising one or more rows (100) of blades of rotors and stators, characterized in that it comprises, in at least one row j (100) of blades of a stage of the axial compressor, the following steps:
a) measuring the following variables:
P_{j;I}: static pressure at the inlet of the row j (100) of blades;
P_{j;O}: static pressure at the outlet of the row j (100) of blades;
h_{j;O}: static enthalpy at the outlet of the row j (100) of blades;
Uⱼ: tangential velocity of the row j (100) of blades;
(Vₓ)_{j;O}: axial velocity at the outlet of the row j (100) of blades;
(V_{θ})_{j;O}: tangential velocity at the outlet of the row j (100) of blades;
γⱼ: ratio of specific heats of the row j (100) of blades;
b) evaluating the risk index for the row j (100), IRⱼ, according to the equation:
$${IR}_{j} = exp [ 1 + \frac{2 {h}_{j ; O} [ {( \frac{{P}_{j ; I}}{{P}_{j ; O}} )}^{\frac{{γ}_{j} - 1}{{γ}_{j}}} - 1 ]}{{[ {( {V}_{x} )}_{j ; O} + {( {σ}_{x} )}_{j} \vert {( {V}_{θ} )}_{j ; O} - {U}_{j} \vert ]}^{2}} ] .$$
wherein for a reference value I_{ref}, in the event that for any of the rows j (100) of rotors for which the value of the risk index IRⱼ has been evaluated is less than or equal to I_{ref}, the result of the prediction for the work conditions of the compressor is instability.

2. The method according to claim 1, characterized in that I_{ref} is 1.

3. The method according to claim 1, characterized in having established a safety value v_{saf}>0, I_{ref} is 1+v_{saf}.

4. The method according to claim 1 characterized in that, having established a risk value vᵣ>0, I_{ref} is 1−vᵣ.

5. The method according to claim 1, characterized in that the measurements taken in step a) are averaged in space, in time or both.

6. A method for protecting an axial compressor, characterized in that given a prediction of instability according to claim 1, the work conditions of the axial compressor are corrected in order to shift it towards the stability region.

7. The method for protecting an axial compressor, characterized in that given a prediction of instability according to claim 1, an alarm signal is provided.

8. The method according to claim 7, characterized in that the risk index IRⱼ is evaluated in a plurality of stages and the alarm signal is provided when any of the risk indexes IRⱼ gives rise to a prediction of instability.

9. The method according to claim 1, characterized in that the measurement of any of the variables necessary for generating the risk index IRⱼ is carried out by any of the following means:
obtaining directly by measuring;
obtaining indirectly by computation from measuring related magnitudes;
obtaining indirectly by computation from related physics equations.

10. A device for predicting the instability of an axial compressor suitable for carrying out a method according to claim 1, characterized in that it comprises in at least one row j (100) of blades of a stage of the axial compressor:
measuring means (101, 102) for obtaining pressure, temperature and velocity values;
a computing device (201) configured for:
performing computations from the measurements obtained by the measuring means (101, 102) to obtain the variables:
P_{j;I}: static pressure at the inlet of the row j (100);
P_{j;O}: static pressure at the outlet of the row j (100);
h_{j;O}: static enthalpy at the outlet of the row j (100);
Uⱼ: tangential velocity of the row j (100);
(Vₓ)_{j;O}: axial velocity at the outlet of the row j (100);
(V_{θ})_{j;O}: tangential velocity at the outlet of the row j (100);
γⱼ: ratio of specific heats of the row j (100);
generating a risk index for the row j (100), IRⱼ, according to the equation:
$${IR}_{j} = exp [ 1 + \frac{2 {h}_{j ; O} [ {( \frac{{P}_{j ; I}}{{P}_{j ; O}} )}^{\frac{{γ}_{j} - 1}{{γ}_{j}}} - 1 ]}{{[ {( {V}_{x} )}_{j ; O} + {( {σ}_{x} )}_{j} \vert {( {V}_{θ} )}_{j ; O} - {U}_{j} \vert ]}^{2}} ] .$$

11. The device according to claim 10, characterized in that it comprises control means (202) suitable for receiving the values of the risk indexes for each row j (100), IRⱼ such that from them they provide a control signal for acting on the geometry and parameters of the compressor.

12. The device according to claim 10, characterized in that it has means for providing an alarm signal when any of the values of IRⱼ are less than or equal to a reference value I_{ref}.

13. The device according to claim 12, characterized in that the means for providing an alarm signal are such that the alarm signal is provided when any of the values of IRⱼ are less than or equal to the reference value I_{ref}.

14. The device according to claim 10, characterized in that the measuring means (101, 102) have means for conditioning the signal.

15. The device according to claim 14, characterized in that the measuring means (101, 102) have spatial averaging means, time averaging means or both for the signal measured.

16. The device according to claim 10, characterized in that obtaining the variables necessary for generating the risk index is carried out by means of any of the following options:
means for obtaining directly by measuring;
means for obtaining indirectly by computation from measuring related magnitudes;
means for obtaining indirectly by computation from related physics equations.
